(19) United States
(12) Patent Application Publication
(10) Pub. No.: US 2018/0137493 A1
(43) Pub. Date: May 17, 2018

(54) Instruction Retrieval System

(71) Applicant: Wal-Mart Stores, Inc., Bentonville, AR (US)

(72) Inventors: Nithya Marannan, Bentonville, AR (US); Tawfeek Abohammdan, Rogers, AR (US); Angela G. Hicks, Fayetteville, AR (US)

(21) Appl. No.: 15/814,905

(22) Filed: Nov. 16, 2017

Related U.S. Application Data
(60) Provisional application No. 62/423,366, filed on Nov. 17, 2016.

(51) Int. Cl. G06Q 20/20; G06K 7/10; G07G 1/00

(52) U.S. Cl. CPC G06Q 20/206; G07G 1/14; G07G 1/0045; G06K 7/10574

(57) ABSTRACT

Described in detail herein are methods and systems to dynamically process machine-readable elements based on an alternate set of instructions associated with an appended portion of an identifier encoded in the machine-readable element.

### CROSS-REFERENCE TO RELATED PATENT APPLICATIONS

This application claims priority to U.S. Provisional Application No. 62/423,366 filed on Nov. 17, 2016, the content of which is hereby incorporated by reference in its entirety.

### BACKGROUND

Scanners may be coupled to computing systems. The scanners may be used to read machine-readable elements such as bar codes that may include an encoded identifier.

### BRIEF SUMMARY

In one embodiment, an instruction retrieval system includes a first computing system including a server and a database. The database stores information associated with different types of physical objects and at least one set of alternate instructions for an identified type of the plurality of types of physical objects. The alternate set of instructions are associated with an identifier. The system further includes a second computing system disposed in a facility and communicatively coupled to the first computing system, a scanner and a printer. The second computing system is programmed to receive alternate sets of instructions from first computing system, scan a first machine-readable element associated with an object of the identified type, identify the identifier as appended to the scanned first machine-readable element, identify at least one alternate set of instructions based on the identifier and execute the identified alternate set of instructions.

In one embodiment, a method for utilizing alternate instructions includes storing via a first computing system, information associated with a different types of physical objects and at least one set of alternate instructions for an identified type of physical object. The alternate set of instructions is associated with an identifier. The method further includes receiving, at a second computing system disposed in a facility that is communicatively coupled to the first computing system, a scanner and a printer, alternate sets of instructions from the first computing system. The method also includes scanning, via the second computing system, a first machine-readable element associated with an object of the identified type and identifying, via the second computing system, the identifier as appended to the scanned first machine-readable element. The method further includes identifying, via the second computing system, at least one alternate set of instructions based on the identifier and executing, via the second computing system, the identified alternate set of instructions.

### BRIEF DESCRIPTION OF DRAWINGS

To assist those of skill in the art in making and using the instruction retrieval system and associated methods, reference is made to the accompanying figures. The accompanying figures, which are incorporated in and constitute a part of this specification, illustrate one or more embodiments of the invention and, together with the description, help to explain the invention. Illustrative embodiments are shown by way of example in the accompanying drawings and should not be considered as limiting. In the figures:

FIG. 1 is a block diagram of exemplary machine-readable elements according to an example embodiment;

FIG. 2 illustrates an exemplary network environment suitable for the instruction retrieval system, in accordance with an exemplary embodiment;

FIG. 3 illustrates an exemplary computing system in accordance with an exemplary embodiment;

FIG. 4 illustrates a flowchart of an exemplary sequence for processing machine-readable elements in an exemplary embodiment; and

FIG. 5 illustrates a flowchart of an exemplary sequence for processing machine-readable elements in another exemplary embodiment when a physical object is not present at a facility.

### DETAILED DESCRIPTION

Described in detail herein are methods and systems for identifying and retrieving alternate instructions. In exemplary embodiments, sets of alternate instructions associated with identifiers can be stored in a database. A first computing system can retrieve the instructions and identifiers and transmit the instructions and identifiers to the second computing system. The second computing system can scan a first machine-readable element associated with an object of the identified type. The second computing system can identify the identifier as appended to the scanned first machine-readable element. The second computing system can identify at least one alternate set of instructions based on the identified identifier and execute the alternate set of instructions.

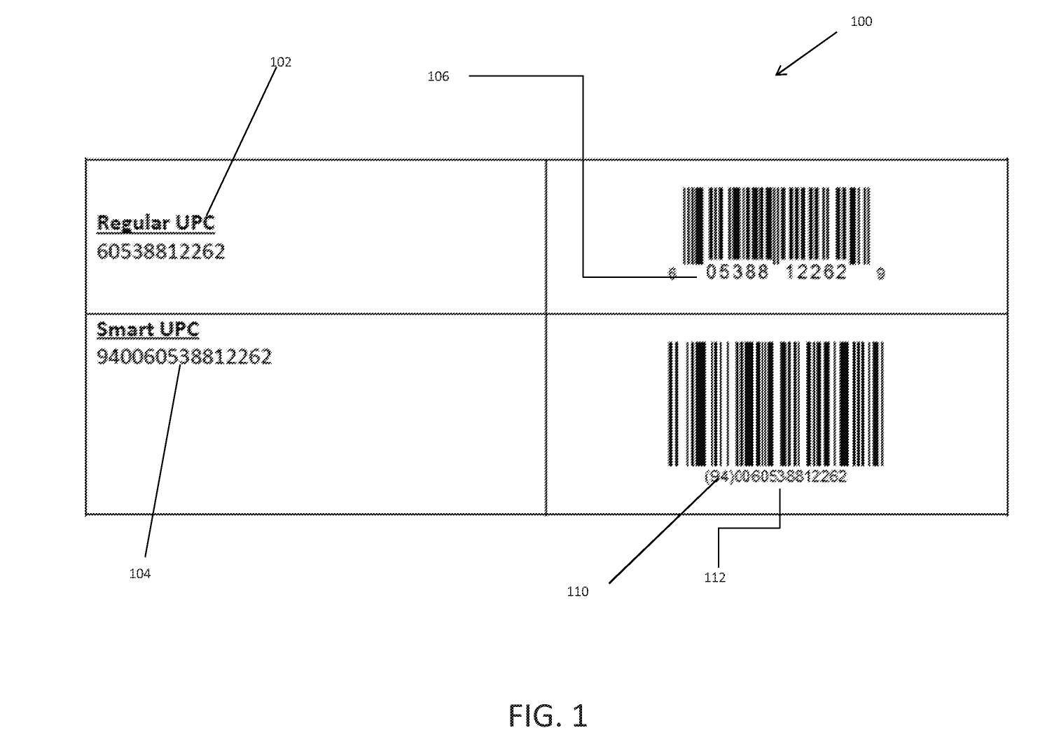

FIG. 1 is a block diagram of exemplary machine-readable elements according to an exemplary embodiment. Physical objects disposed in a facility can be identified by machine-readable elements 100. The machine-readable elements 100 can be barcodes or QR codes. The machine-readable elements 100 can include identifiers encoded within the machine-readable elements, identifying the physical object. A scanner or reader (not shown) can scan and decode the identifiers from machine-readable elements 100 and transmit the decoded identifiers to a computing system. Each identifier can trigger a varied instructions on the computing system based on the type of identifier. The identifier can be alpha-numeric characters.

In exemplary embodiments, a first identifier 102 can be associated with a set of like physical objects. The first identifier 102 can be encoded in the first machine readable element 106. The first identifier 102 can also be presented below the machine-readable element 106. A second identifier 104 can be associated with a subset of the set of like physical objects. The second identifier 104 can include all the alpha-numeric characters of the first identifier 102 and include an appended alpha-numeric prefix 110. The alpha-numeric characters of the first identifier 102 can identify the set of like physical objects and the appended prefix 110 can identify the subset of the set of like physical objects. The second identifier 104 including the appended prefix 110 can be encoded in the second machine readable element 112. The second identifier 104 including the appended prefix can be presented below the second machine readable element 112. In one example, the second machine readable element 112 can be a GS1 Extended Barcode.

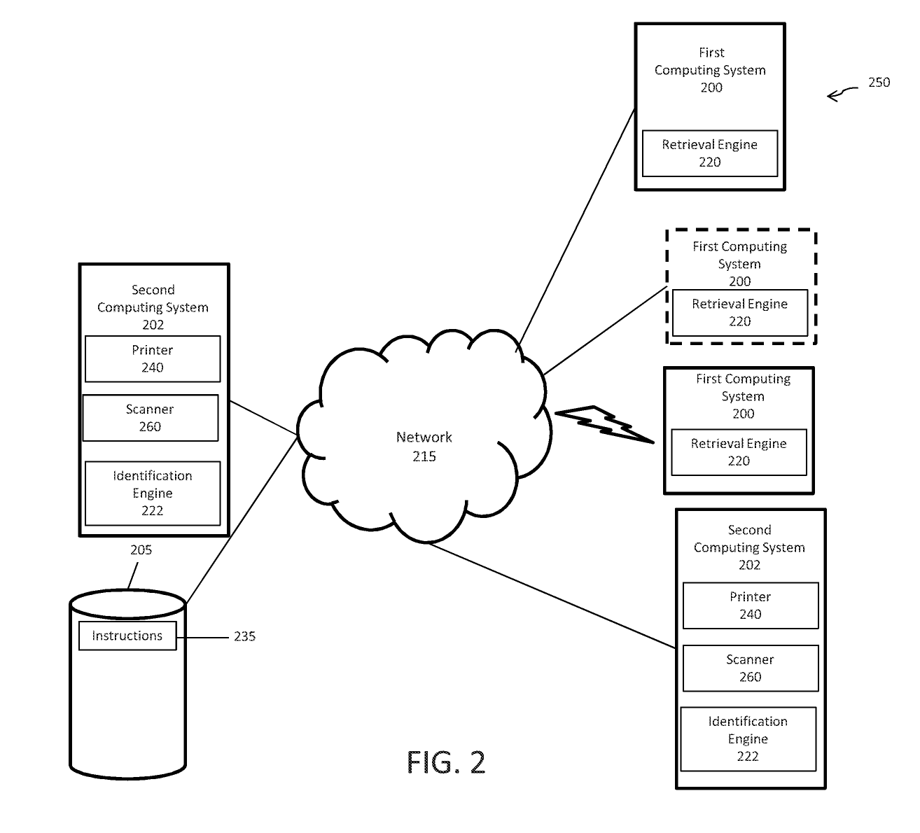

FIG. 2 illustrates an exemplary network environment suitable for the alternate instruction processing system, in accordance with exemplary embodiments. The alternate instruction processing system 250 can include one or more databases 205, one or more first computing systems 200 and one or more second computing systems 202. In exemplary embodiments, the first computing system 200 is in communication with the databases 205, and the second computing system 202 via a first communications network 215. The first computing system 200 can implement at least one instance of the retrieval engine 220. The second computing system 202 can implement at least one instance of the identification engine 222. The second computing system 202 can also include a printer 240 and a scanner 260.

In an example embodiment, one or more portions of the first and second communications network 215, 217 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The databases 205 are connected to the communications network 215 via a wired or wireless connection. The first computing system 200 includes one or more computers or processors configured to communicate with the second computing system 202 and the databases 205, via the first network 215. The first computing system 200 hosts one or more applications configured to interact with one or more components of the second computing system 200, 202 and/or facilitates access to the content of the databases 205. The databases 205 may store information/data, as described herein. For example, the databases 205 can include an instructions database 235. The instructions database 235 can store instructions associated with processing identifiers encoded in machine-readable elements that are associated with physical objects disposed in a facility. The databases 205 can be located at one or more geographically distributed locations from each other or from the first computing system 200. Alternatively, the databases 205 can be included within computing system 200.

In exemplary embodiments, physical objects can be disposed in a facility. The physical objects can be identified by identifiers encoded in machine-readable elements . Each identifier can represent a set of like products disposed in the retail store. The identifier can also include an appended prefix or postfix portion for a subset of the set of like physical objects disposed in the retail store. The appended portion can indicate a subset of physical objects to be processed in an alternate manner based on an alternate set of instructions as compared to the set of like physical objects associated with identifiers not including the appended portion.

For example, one or more alternate set of instructions associated with one or more of the physical objects can be input into the instructions database 235. The first computing system 200 can detect the new alternate set(s) of instructions input in the instructions database 235 associated with the one or more physical objects disposed in the facility. The first computing system 200 can execute the retrieval engine 220 in response to detecting the new alternate set(s) of instructions input in the instructions database 235 and can query the instructions database to retrieve the new alternate set(s) of instructions associated with an appended portion of an identifier. The retrieval engine 220 can transmit the one or more alternate set of instructions along with the identifiers to the second computing system 202. In some embodiments, the retrieval engine 220 can transmit instructions and identifiers in response to detecting the instructions and identifiers being input in the instructions database 235. In other embodiments, the retrieval engine 220 can transmit the instructions and identifiers as part of a batch job executed after a predetermined amount of time.

The second computing system 202 can receive the alternate sets of instructions from the first computing system 202. The second computing system 202 can be disposed in a facility. In one embodiment, multiple second computing systems 202 disposed in a facility may receive identical alternate sets of instructions The instructions and identifiers received by the second computing system can be associated with physical objects designated to be disposed in the same facility as the second computing system. The second computing system 202 can receive a decoded first identifier in response to scanning a first machine readable element using a scanner 260. The second computing system 202 can execute an identification engine 220 in response to receiving the first identifier. The identification engine 220 can determine that the first identifier associated with a physical object includes an appended pre-fix or post-fix portion indicative of an alternate set of instructions. The identification engine 220 can identify an alternate set of instructions associated with the first identifier from among the received alternate sets of instructions based on the appended portion of the identifier.

The identification engine 202 can execute the identified alternate set of instructions with respect to the physical object. By using the appended portion to identify an alternate set of instructions stored on the second computing system, the second computing system 202 avoids the need to query multiple databases thus reducing network communication and increasing the response speed of both the network and the second computing system. In some embodiments, the execution of the identified alternate set of instructions determines the amount of times the first machine-readable element has been scanned in the facility and whether the number of times the first machine-readable element has been scanned is within a predetermined threshold. In other embodiments, in response to the execution of the alternate set of instructions, the identification engine 222 determines that the first machine-readable element has been scanned within a pre-determined interval. In another embodiment, as a result of the execution of the alternate set of instructions, the identification engine 222 determines the number of times that the first machine-readable element has been scanned within a pre-determined interval.

In one embodiment, in response to determining that the number of times the first machine-readable element with the appended portion has been scanned is within a predetermined threshold and/or has been scanned within a predetermined time, the second computing system can encode the first identifier with the appended portion into a second machine-readable element. The identification engine 222 can control the printer 240 to print the second machine-readable element which may be given to an individual interacting with the second computing system. The identification engine 222 can transmit the result of the execution of the alternate set of instructions to the first computing system 200. In some embodiments, in response to determining that the first machine readable element has scanned over the predetermined threshold number of times or has not been scanned within a predetermined time interval, the second computing system may not print the second machine-readable element encoded with the first identifier including the appended portion. The second computing system 202 can print using the printer, a second machine-readable element encoded with the first identifier excluding the appended portion.

In an embodiment, the identification engine 222 can determine the physical object associated with the first identifier is not present in the facility. The identification engine 222 can determine the physical object associated with the first identifier present at a second facility. The identification engine 222 can transmit instructions to the second facility to deliver the physical object to a specified address such as the location of the second computing system or to another designated location.

As a non-limiting example, the machine-readable element processing system 250 can be implemented in a retail store. The retail store can have machine-readable elements encoded with identifiers associated with products disposed in the retail store. Each identifier can represent a type of product disposed in the retail store. The identifier can include an appended prefix or postfix portion for a subset of the set of like products disposed in the retail store. The appended portion can indicate subset of products can be processed in an alternate manner based on an alternate set of instructions, as compared to the set of like products associated with identifiers not including the appended portion. For example, the retail store can have a promotion of providing a discount for the first 100 units of a gaming system sold on a certain date. In another example, the retail store can have a promotion of providing a discount for the first specified number of units of a gaming system sold within a predetermined amount of time. In yet another example, an online store may be having a sale on a set of products and a customer can chose to purchase the products at a retail store. The alternate set of instructions associated with the product at the retail store can include instructions for the product to be processed as a virtual sale.

In exemplary embodiments, one or more alternate set of instructions associated with one or more of the products can be input in the instructions database 235. The first computing system 200 can programmatically detect the new one or more alternate set of instructions input in the instructions database 235 associated with the one or more products disposed in the retail store. The first computing system 200 can execute the retrieval engine 220 in response to detecting the new one or more alternate set of instructions input in the instructions database 235. The retrieval engine 220 can query the instructions database to retrieve the one or more alternate sets of instructions along with the identifier including an appended portion identifying the alternate set of instructions and the portion identifying the physical object. The retrieval engine 220 can transmit the one or more alternate set of instructions along with the identifiers to the second computing system 202. In some embodiments, the retrieval engine 220 can transmit the alternate set(s) of instructions associated with identifiers having appended portions in response to detecting the alternate set(s) of instructions being input in the instructions database 235. In other embodiments, the retrieval engine 220 can transmit the alternate set(s) of instructions as part of a batch job executed after a predetermined amount of time.

The second computing system 202 can receive the alternate set(s) of instructions from the first computing system 202. The second computing system 202 can receive a decoded first identifier with an appended portion in response to a scanner 260, scanning and decoding the first identifier from a first machine-readable element associated with a product. In some embodiments, the second computing system 202 can be a POS terminal in a store and all of the POS terminals in the facility may store the alternate sets of instructions. The second computing system 202 can execute the identification engine 222 in response to receiving the first identifier. The identification engine 220 can determine that the machine-readable element associated with physical object includes an appended pre-fix or post-fix portion indicative of an alternate set of instructions. The identification engine 220 can identify an alternate set of instructions associated with the first identifier from among the received alternate sets of instructions based on the appended portion of the identifier.

The identification engine 222 can execute the identified set of instructions with respect to the product. In response to scanning the identifier associated with the set of like products including the appended portion, the POS terminal can retrieve the pre-loaded alternate set of instructions for processing the transactions associated with the promotion for the set of like products. For example, the identification engine 222 can process the transaction of a product at the POS system without querying any databases. The instructions can include information associated with the product such as type of sale, promotion information, price and inventory information. Since the instructions associated with the product are pre-loaded onto the POS terminal, the POS terminal can complete the transaction without the need to interface with multiple computing systems thus proving the efficiency of the computing environment.

In some embodiments, the execution of the alternate set of instructions determines the amount of times the first machine-readable element has been scanned in the facility and whether the number of times the first machine-readable element has been scanned is within a predetermined threshold. In other embodiments, in response to the execution of the alternate set of instructions, the identification engine 222 determines whether the first machine-readable element has been scanned within a pre-determined interval. As an example, the identification engine 222 can determine whether there is a promotion providing a discount for the first predetermined amount of units of a product sold on a certain date, based on the alternate set of instructions. Alternatively, the promotion can provide a discount for a product sold within a predetermined amount of time. The identification engine 222 can determine whether the product qualifies for the promotion by determining how many times the first machine-readable element has been scanned in the retail store on that day and/or determine whether the first machine-readable element was scanned within a predetermined amount of time.

In some embodiments, in response to determining that the product qualifies for the promotion, the identification engine 222 can determine whether the product is present in the retail store. In response to determining that the product is not present at the retail store and qualifies for the promotion, the identification engine 222 can encode the first identifier including the appended portion in a second machine-readable element. The identification engine 222 can control the printer 240 to print the second machine-readable element encoded with the first identifier including the appended portion. The second machine-readable element can be a rain check to pick up the product at a later date while still qualifying for the promotion. In some embodiments, the identification engine 222 can determine the product is available at a second retail store and the identification engine 222 can print the second machine-readable element encoded with the first identifier including the appended portion. The second machine-readable element can be used to pick up the product at the second retail store. The identification engine 222 can also have the product delivered to a specified address from the second retail store.

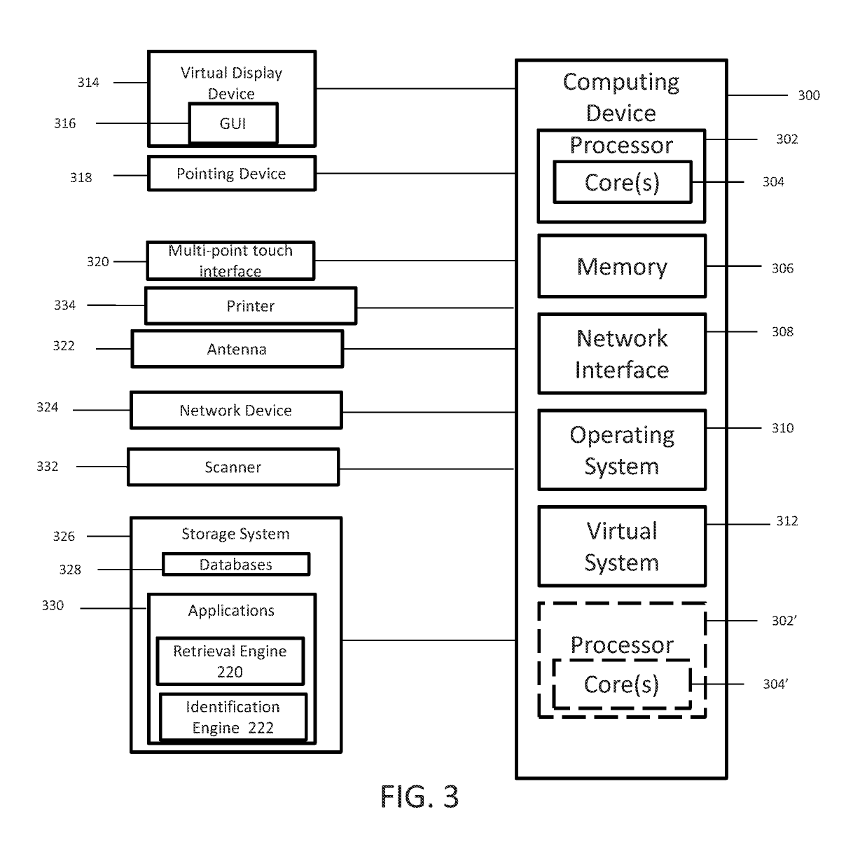

FIG. 3 is a block diagram of an example computing device for implementing an exemplary embodiment. Embodiments of the computing device 300 can execute the identification engine and the retrieval engine. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330 such as identification engine 222 and retrieval engine 220) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 406 may include other types of memory as well, or combinations thereof.

A user may interact with the computing device 300 through a visual display device 314, such as a computer monitor, which may display one or more graphical user interfaces 316, multi touch interface 320, a scanner 332, a printer 334 and a pointing device 318.

The computing device 300 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information regarding the physical objects and instructions. The databases 328 may be updated manually or automatically at any suitable time to add, delete, and/or update one or more data items in the databases. The databases 328 can include information such as instructions database 235. The instructions database 235 can store information associated with instructions regarding physical objects.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run operating system 310, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device 300 and performing the operations described herein. In exemplary embodiments, the operating system 310 may be run in native mode or emulated mode. In an exemplary embodiment, the operating system 310 may be run on one or more cloud machine instances.

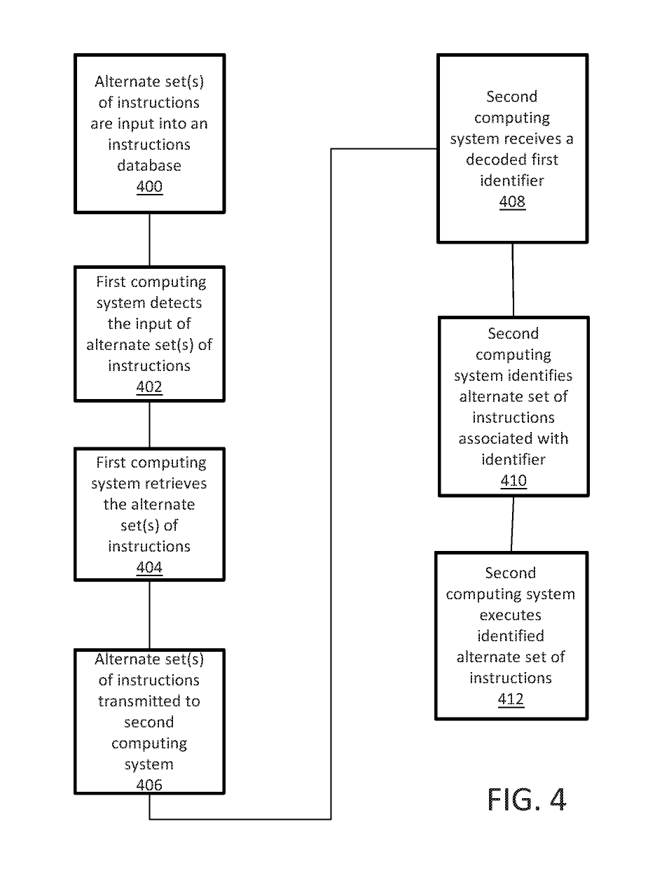

FIG. 4 illustrates an exemplary sequence for processing machine-readable elements in an exemplary embodiment. . In operation 400, alternate sets of instructions associated with physical objects are input into an instructions database (e.g. instructions database 235 as shown in FIG. 2). The alternate set of instructions reference identifiers (e.g. second identifier 104 as shown in FIG. 1) for the physical objects that include appended portions such as portions appended as either a pre-fix or post-fix. The appended portions are used to identify the alternate set of instructions which need to be executed. In operation 402, the first computing system (e.g. first computing system 200 as shown in FIG. 2) detects the input of the alternate sets of instructions in the instructions database. The first computing system executes the retrieval engine (e.g. retrieval engine 220 as shown in FIG. 2) in response to detecting the alternate sets of instructions input in the instructions database. In operation 404, the first computing system 200 retrieves the alternate sets of instructions input in the instructions database . In operation 406, the first computing system 200 transmits the instructions and identifiers to a second computing system (e.g. second computing system 202 as shown in FIG. 2).

In operation 408, the second computing system can receive a decoded first identifier, in response to a scanner (e.g. scanner 260 as shown in FIG. 2) scanning a first machine readable element in which the first identifier was encoded. The identifier can be associated with a physical object disposed in a facility. The second computing system can execute an identification engine (e.g. identification engine 222 as shown in FIG. 2) in response to receiving the first identifier. The identification engine can determine the first identifier includes an appended portion. In operation 410, second computing system identifies an alternate set of instructions to process the identifier based on the appended portion. The identification engine can retrieve the identified alternate set of instructions correlated to the matched identifier. In operation 412, the second computing system can execute the alternate set of instructions thus providing an alternate process flow for handling the physical object associated with the identifier.

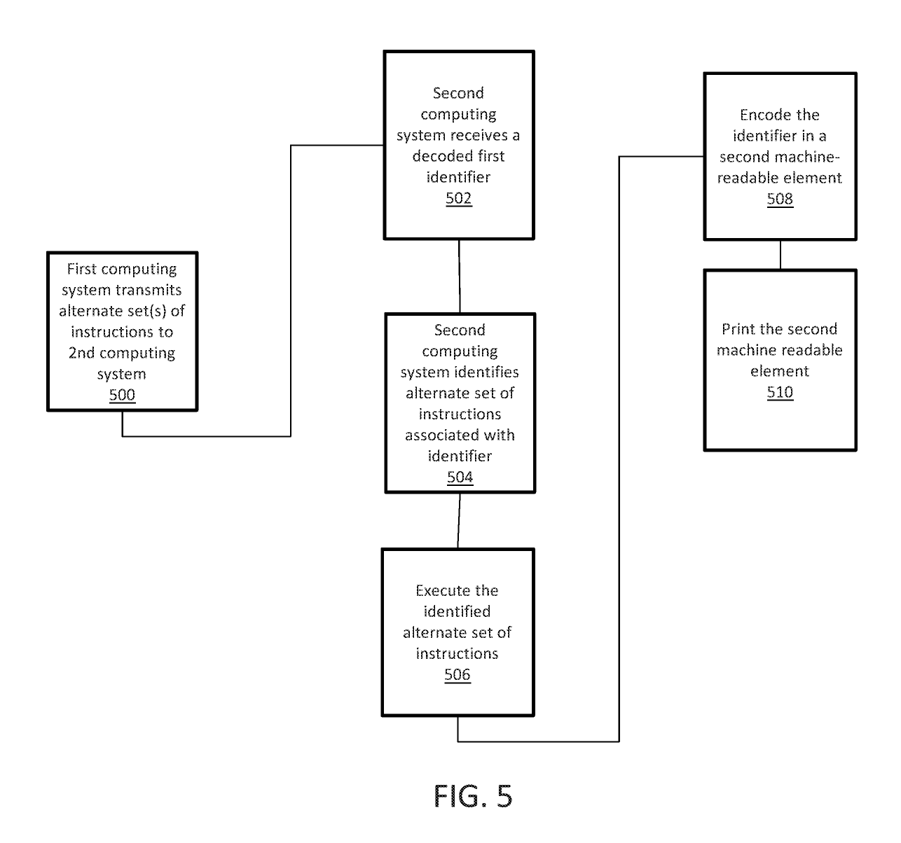

FIG. 5 illustrates a flowchart of an exemplary sequence for processing machine-readable elements in an exemplary embodiment when a physical object is not present at a facility. The sequence begins in operation 500 when the first computing system transmits the alternate sets of, instructions associated with physical objects and identifiers including appended portions as described above to a second computing system. In operation 502, the second computing system can receive a decoded first identifier, in response to a scanner (e.g. scanner 260 as shown in FIG. 2) scanning a first machine readable element in which the first identifier was encoded. The identifier can be associated with a physical object disposed in a facility. The second computing system can execute the identification engine (e.g. identification engine 222 as shown in FIG. 2) in response to receiving the first identifier. The identification engine can determine that the first identifier includes an appended portion. In operation 504, the identification engine identifies the alternate set of instructions associated with the appended portion of the identifier.. The identification engine can retrieve the set of instructions correlated to the matched identifier. In operation 506, the identification engine can execute the identified alternate set of instructions. In operation 508, the identification engine can encode the identifier in a second machine-readable element. The identification engine can also determine the physical object is not present at the facility. In operation 510, the identification engine can control the printer (e.g. printer 240 as shown in FIG. 2) to print the second machine readable element. In one embodiment, the printed second machine readable element can be given as a rain check to obtain the object at another location and/or another time.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An instruction retrieval system, the system including:
a first computing system including a server and a database, the database storing information associated with a plurality of types of physical objects and at least one set of alternate instructions for an identified type of the plurality of types of physical objects, the alternate set of instructions associated with an identifier;
a second computing system disposed in a facility and communicatively coupled to the first computing system, a scanner and a printer, the second computing system programmed to:
receive a plurality of alternate sets of instructions from first computing system;
scan a first machine-readable element associated with an object of the identified type ;
identify the identifier as appended to the scanned first machine-readable element;
identify at least one alternate set of instructions based on the identifier; and
execute the identified at least one alternate set of instructions.

2. The system of claim 1, wherein, based on the execution of the alternate set of instructions the second computing system encodes the identifier into a second machine-readable element, controls the printer to print the second machine-readable element and transmits a result of the execution of the alternate set of instructions to the first computing system.

3. The system of claim 1, wherein the execution of the alternate set of instructions at the second computing system determines an amount of times the first machine-readable element has been scanned in the facility.

4. The system of claim 3, wherein the execution of the alternate set of instructions determines whether the amount of times the first machine-readable element has been scanned in the facility is within a predetermined threshold.

5. The system of claim 3 wherein the second machine readable element is printed only when the amount of times exceed the predetermined threshold.

6. The system of claim 1, wherein the execution of the alternate set of instructions at the second computing system determines an amount of times the first machine-readable element has been scanned in the facility within a pre-determined time interval.

7. The system of claim 1, wherein the second computing system determines that the object of the identified type is not present in the first facility in response to scanning the first machine readable element.

8. The system of claim 7, wherein the object of the identified type is determined to be available at a second facility in response to determining that the object of the identified type is not present in the first facility.

9. The system of claim 8, wherein the first computing system is configured to transmit instructions to the second facility to transport a quantity of the object of the identified type from the second facility to a specified address.

10. A method for utilizing alternate instructions, the method including:
storing, via a first computing system, information associated with a plurality of types of physical objects and at least one set of alternate instructions for an identified type of the plurality of types of physical objects, the alternate set of instructions associated with an identifier;
receiving, at a second computing system disposed in a facility and communicatively coupled to the first computing system, a scanner and a printer, a plurality of alternate sets of instructions from the first computing system;
scanning, via the second computing system, a first machine-readable element associated with an object of the identified type;
identifying, via the second computing system, the identifier as appended to the scanned first machine-readable element;
identifying, via the second computing system, at least one alternate set of instructions based on the identifier; and
executing, via the second computing system, the identified alternate set of instructions.

11. The method of claim 10, further comprising:
encoding, via the second computing system, the identifier into a second machine-readable element;
controlling, from the second computing system, a printer to print the second machine-readable element based on the execution of the alternate set of instructions, and
transmitting, via the second computing system, a result of the execution of the alternate set of instructions to the first computing system.

12. The method of claim 10, wherein the execution of the alternate set of instructions at the second computing system determines an amount of times that the first machine-readable element has been scanned in the facility.

13. The method of claim 12, wherein the execution of the alternate set of instructions determines whether the amount of times that the first machine-readable element has been scanned in the facility is within a predetermined threshold.

14. The method of claim 12, wherein the second machine readable element is printed in response to the amount of times exceeding the predetermined threshold.

15. The method of claim 10, wherein the execution of the alternate set of instructions at the second computing system determines an amount of times that the first machine-readable element has been scanned in the facility within a pre-determined time interval.

16. The method of claim 10, further comprising:
determining, via the second computing system, that the object of the identified type is not present in the first facility in response to scanning the first machine readable element.

17. The method of claim 16, further comprising:
determining, via the second computing system, that the object of the identified type is available at a second facility in response to determining the object of the identified type is not present in the first facility.

18. The method of claim 17, further comprising:
transmitting, via the first computing system, instructions to the second facility to transport a quantity of the object of the identified type from the second facility to a specified address.
